(19) United States
(12) Patent Application Publication
(10) Pub. No.: US 2008/0179432 A1
(43) Pub. Date: Jul. 31, 2008

(54) Spreader Covers

(76) Inventor: William Hodge, Olmsted Falls, OH (US)

Correspondence Address: Casimir Jones, S.C., 440 Science Drive, Suite 203, Madison, WI, 53711, US

(21) Appl. No.: 12/014,324

(22) Filed: Jan. 15, 2008

Related U.S. Application Data
(60) Provisional application No. 60/897,951, filed on Jan. 29, 2007.

(51) Int. Cl. B65D 43/20; A01C 15/00; A01C 17/00; B65B 1/04; B65D 51/00

(52) U.S. Cl. 239/650; 220/377; 141/2; 220/345.1; 220/324; 49/404

(57) ABSTRACT

The present invention provides spreader covers and methods of using the spreader covers. Specifically, the present invention provides spreader covers that are generally rigid that are configured for enclosing the hopper of a spreader device (e.g., to protect from rain and/or spillage). In certain embodiments, the generally rigid spreader covers enclosing the top of a hopper may be slid back, along the hopper opening ridge, to allow material to be added to the hopper without removing the spreader cover.

The present application claims priority to U.S. Provisional Application Ser. No. 60/897,951 filed Jan. 29, 2007, which is herein incorporated by reference in its entirety.

### FIELD OF THE INVENTION

The present invention relates to spreader covers and methods of using the spreader covers. Specifically, the present invention provides spreader covers that are generally rigid that are configured for enclosing the hopper of a spreader device (e.g., to protect from rain and/or spillage). In certain embodiments, the generally rigid spreader covers enclosing the top of a hopper may be slid back, along the hopper opening ridge, to allow material to be added to the hopper without removing the spreader cover.

### BACKGROUND OF THE INVENTION

It is well known in the art to use material spreader devices to distribute all types of spreadable material over a selected ground area. Such material spreader devices distribute fertilizers, pesticides, seeds, salt, or other materials in particulate or finely divided form over a selected ground area. Generally, material spreaders known in the art can be classified in two general categories: broadcast spreaders and drop spreaders. All types of spreaders, however, suffer from the problem of enclosing the top of the hopper of the spreader device to protect against rain and spillage. Covers known in the art are flexible, elastic based covers that are subject to numerous problems, such as ripping, pooling of water, and the need to take the cover completely off when re-filling the hopper. As such, what is needed in the art are covers that address these limitations.

### SUMMARY OF THE INVENTION

The present invention provides spreader covers and methods of using the spreader covers. Specifically, the present invention provides spreader covers that are generally rigid that are configured for enclosing the hopper of a spreader device (e.g., to protect from rain and/or spillage). In certain embodiments, the generally rigid spreader covers enclosing the top of a hopper may be slid back, along the hopper opening ridge, to allow material to be added to the hopper without removing the spreader cover.

In some embodiments, the present invention provides systems comprising: a) a spreader device comprising a hopper with a hopper opening and hopper opening ridge, wherein the hopper is configured for holding a supply of spreadable material, and b) a spreader cover that is configured to slide over the hopper opening ridge such the spreader cover is capable of fully enclosing the hopper opening of the hopper (and/or such that the spreader cover is secured to the hopper), wherein the spreader cover comprises: i) a top panel that is substantially rigid and is configured to cover the hopper opening of the hopper, ii) a back rail attached to, or integral with, the top panel, iii) a first side rail attached to, or integral with, the top panel, wherein the first side rail comprises a first dove-tail rail, and iv) a second side rail attached to, or integral with, the top panel, wherein the second side rail comprises a second dove-tail rail.

In certain embodiments, the present invention provides a spreader cover that is configured to slide over the hopper opening ridge of a hopper of a spreader device such that the spreader cover is capable of fully enclosing the hopper opening of the hopper (and/or such that the spreader cover is secured to the hopper), wherein the hopper is configured for holding a supply of spreadable material, wherein the spreader cover comprises: a) a top panel that is substantially rigid and is configured to cover the hopper opening of the hopper, b) a back rail attached to, or integral with, the top panel, c) a first side rail attached to, or integral with, the top panel, wherein the first side rail comprises a first dove-tail rail, and d) a second side rail attached to, or integral with, the top panel, wherein the second side rail comprises a second dove-tail rail.

In particular embodiments, the present invention provides methods of filling a spreader comprising: a) providing: i) a spreader device comprising a hopper with a hopper opening and hopper opening ridge, wherein the hopper is configured for holding a supply of spreadable material, and ii) a spreader cover that is attached to the hopper such the spreader cover fully encloses the hopper opening of the hopper, wherein the spreader cover comprises: A) a top panel that is substantially rigid and is configured to cover the hopper opening of the hopper, B) a back rail attached to, or integral with, the top panel, C) a first side rail attached to, or integral with, the top panel, wherein the first side rail comprises a first dove-tail rail, and D) a second side rail attached to, or integral with, the top panel, wherein the second side rail comprises a second dove-tail rail; and b) sliding the spreader cover back along the hopper opening ridge such that the spreader cover partially encloses the hopper opening of the hopper; and c) pouring spreadable material into the hopper of the spreader device.

In certain embodiments, the spreader device is a broadcast spreader or drop spreader. In some embodiments, the spreader cover is composed of plastic (e.g., generally rigid plastic). In other embodiments, the spreader cover is transparent.

In other embodiments, the top panel has a length of about 21½ inches and a width of about 18½ inches. In further embodiments, the top panel has a length of about 28⅜ inches and width of about 18⅜ inches. In other embodiments, the top panel has a length of about 21¼ inches and a width of about 18½ inches. In further embodiments, the top panel has a length of about 21½ inches and width of about 18½ inches. In other embodiments, the top panel has a length of about 28⅜ inches and a width of about 18⅜ inches. In further embodiments, the top panel has a length of about 23⅞ inches and width of about 21 inches. In other embodiments, the top panel has a length of about 23½ inches and a width of about 20 inches. In further embodiments, the top panel has a length of about 26 inches and width of about 19 inches. In other embodiments, the top panel has a length of about 34 inches and a width of about 26 inches. In further embodiments, the top panel has a length of about 22 inches and width of about 19.5 inches. In particular embodiments, the spreader covers are configured to attach to hoppers of spreaders from LESCO, PERMAGREEN (e.g., ride-on spreaders), hopper extensions from LESCO, Z-SPRAYER spreader (L.T. Riche), and TIME MACHINE spreader sprayer (C&S Turf).

### DESCRIPTION OF THE FIGURES

FIG. 1 shows an exemplary broadcast spreader device.

FIG. 2 shows an exemplary spreader cover.

FIGS. 3A-C shows various angles of an exemplary spreader cover.

FIG. 4 shows a back view of a fertilizer spreader with an exemplary see-through spreader cover covering the hopper opening. The exemplary spreader cover is shown with a handle centrally located along one side of the cover that allows the cover to be slid open revealing the hopper below (e.g., such that additional fertilizer can be added in the hopper).

FIG. 5 shows a back view of a fertilizer spreader with an exemplary see-through spreader cover slid nearly to the end of the hopper exposing substantially the entire hopper, which allows additional fertilizer or other material to be added to the hopper.

FIG. 6 shows a side view of a fertilizer spreader with an exemplary see-through spreader cover slid nearly to the end of the hopper.

FIG. 7 shows a front view of a fertilizer spreader with an exemplary see-through spreader cover covering the hopper opening.

FIG. 8 shows a side view of a fertilizer spreader with an exemplary see-through spreader cover slid about half-way back. This figure also shows additional fertilizer being poured into the hopper.

### GENERAL DESCRIPTION OF THE INVENTION

The present invention provides spreader covers and methods of using the spreader covers. Specifically, the present invention provides spreader covers that are generally rigid that are configured for enclosing the hopper of a spreader device (e.g., to protect from rain and/or spillage). In certain embodiments, the generally rigid spreader covers enclosing the top of a hopper may be slid back, along the hopper opening ridge, to allow material to be added to the hopper without removing the spreader cover.

The spreader covers of the present invention have many advantages over spreader covers known in the art. For example, in preferred embodiments, the spreader covers of the present invention are composed of generally rigid materials, such as stiff plastic, metal, or wood, such that the spreader cover itself is generally rigid. As a result, the spreader covers are not subject to tearing, ripping or getting unwanted holes like the flexible spreader covers of the prior art. Another advantage is that the generally rigid nature of spreader covers of the present invention prevents water (e.g., rain water) from pooling on the top of the cover (which can cause pools of water to leak into the hopper when the cover is removed to re-fill the hopper). A further advantage of the spreader covers of the present invention is that they do not need to be completely removed in order to re-fill the hopper. Instead, they can be pulled back part way without falling off while the user re-fills the hopper. This is an improvement over the flexible spreader covers of the prior art which generally have to be completely removed in order to re-fill the hopper.

### DETAILED DESCRIPTION OF THE INVENTION

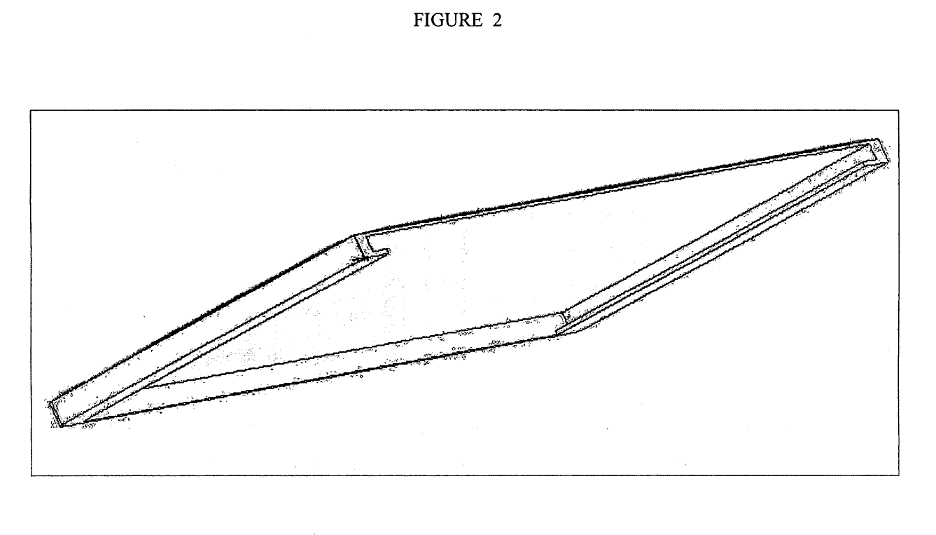

Although not limited to any particular configuration, FIGS. 2-8 show various preferred protective articles of the present invention. These exemplary embodiments are described below to further illustrate the present invention and are not to be construed as limiting in any manner.

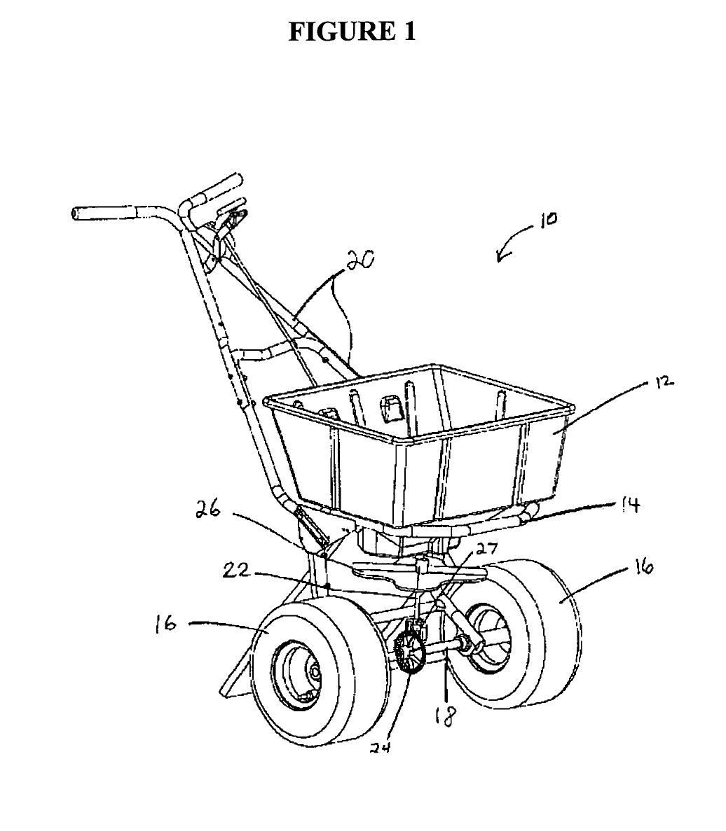

FIG. 1 shows an exemplary spreader device 2. FIG. 1 shows that the spreader device 2 has a hopper 4, a hopper opening 6 of the hopper, and a hopper opening ridge 7.

FIG. 2 shows an exemplary spreader cover 8 of the present invention. The exemplary spreader cover 8 includes a top panel 10, a back rail 12, a first side rail 14, having a first dove-tail rail 16 (which allows the spreader cover to slide on and be secured to the hopper opening ridge), a second side rail 18 (opposite of the first side rail 14) having a second dove tail rail 20 (e.g., which allows the spreader cover to slide on and be secured to the hopper opening ridge). The exemplary spreader cover 8 also includes, in certain embodiments, a drill hole 22, which may be use with a pin to prevent the spreader cover 8 from shifting during use.

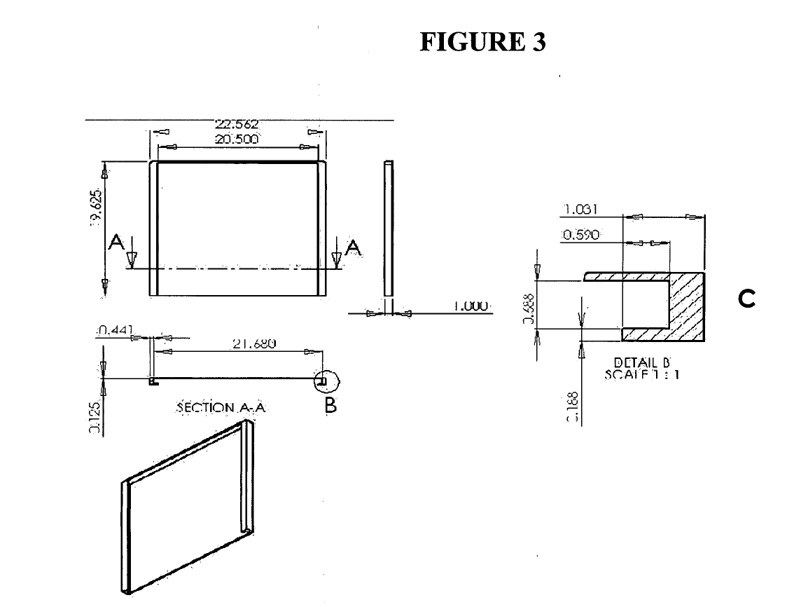

FIG. 3A shows a bottom view of an exemplary spreader cover 8, with a top panel 10, a back rail 12, a first side rail 14, a first dove tail rail 16, and a second dove tail rail 20. FIG. 3B shows bottom off-set view of an exemplary spreader cover 8, with a top panel 10, a back rail 12, a first dove tail rail 16, and second side rail 18, and a second dove tail rail 20. FIG. 3C shows a cut-away view of portion B of the exemplary spreader cover 8. This cut-away view shows part of the top cover 10, first side rail 14, and first dove tail rail 16.

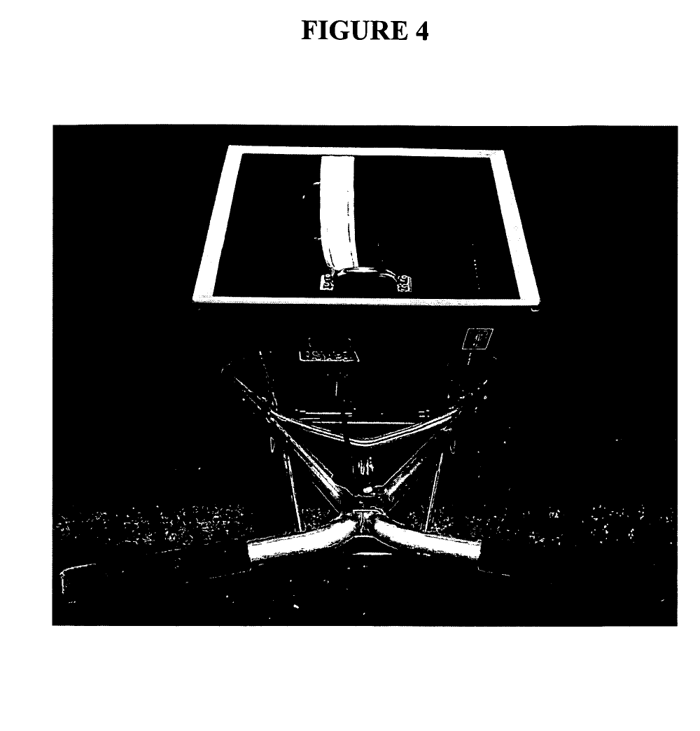

FIG. 4 shows a back view of a fertilizer spreader with an exemplary see-through spreader cover covering the hopper opening. The exemplary spreader cover is shown with a handle centrally located along one side of the cover that allows the cover to be slid open revealing the hopper below (e.g., such that additional fertilizer can be added in the hopper). The present invention is not limited by the type of handle that is employed. In some embodiments, it is substantially as shown in FIG. 4. In other embodiments, it is a knob, or a post, similar component that can be grasped. In other embodiments, indentations are made in the cover such that one can slide the cover back without using an additional handle.

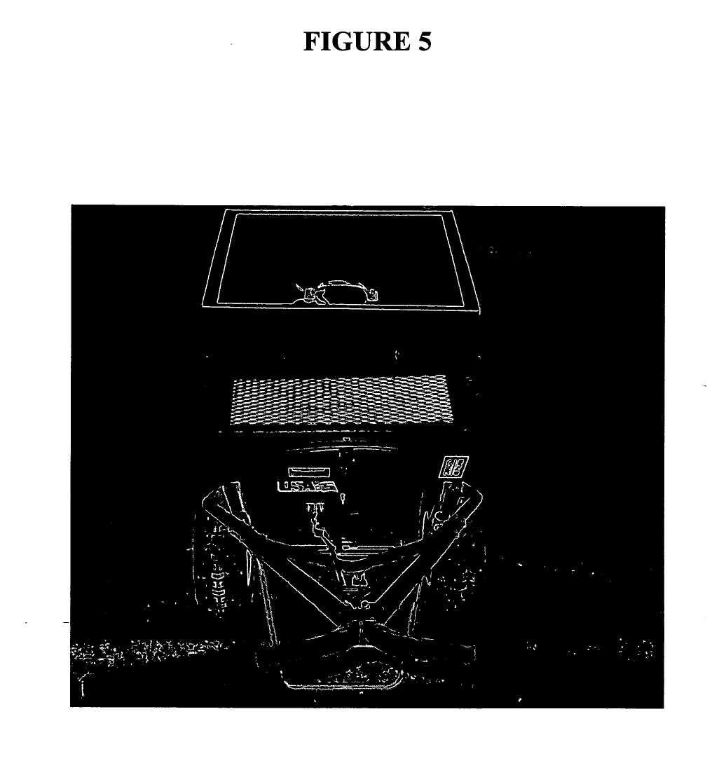

FIG. 5 shows a back view of a fertilizer spreader with an exemplary see-through spreader cover slid nearly to the end of the hopper exposing substantially the entire hopper, which allows additional fertilizer or other material to be added to the hopper. As shown in this figure, one advantage of the spreader covers of the present invention is that they can be slid open revealing substantially the entire hopper without having to be held in place by an user (e.g., a user has two hands free to load the hopper or perform other tasks).

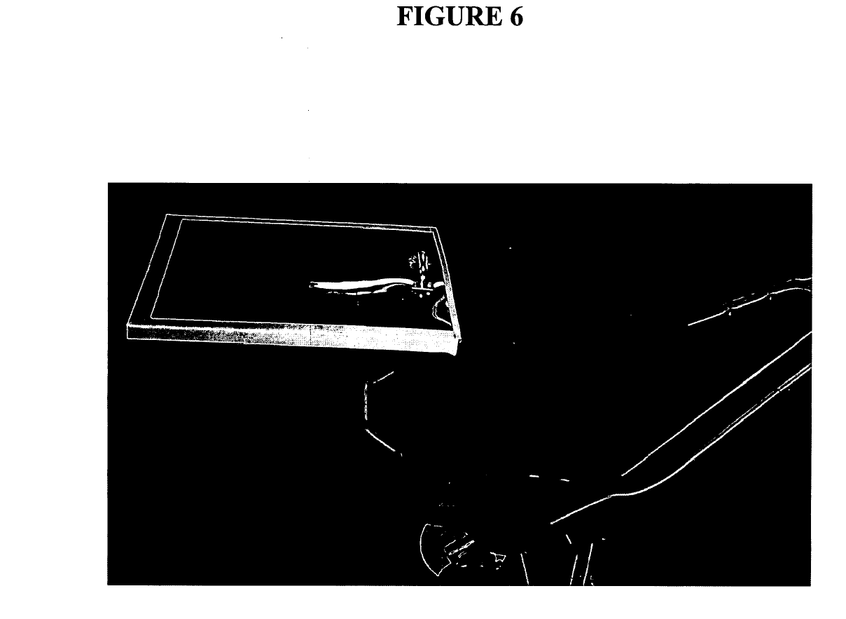

FIG. 6 shows a side view of a fertilizer spreader with an exemplary see-through spreader cover slid nearly to the end of the hopper. As shown in this figure, the spreader cover may be see-through. This has the advantage of allowing the user to see if new material needs to be added to the hopper without removing the cover.

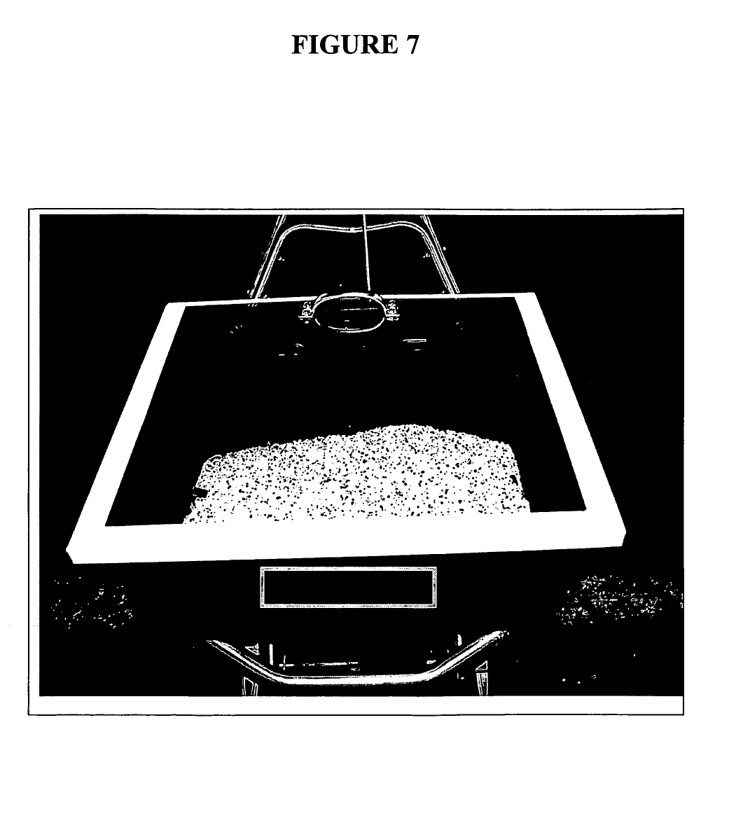

FIG. 7 shows a front view of a fertilizer spreader with an exemplary see-through spreader cover covering the hopper opening. In certain embodiments, when the spreader cover fully covers the hopper, the hopper is moisture proof (e.g., prevents rain or snow from entering the hopper).

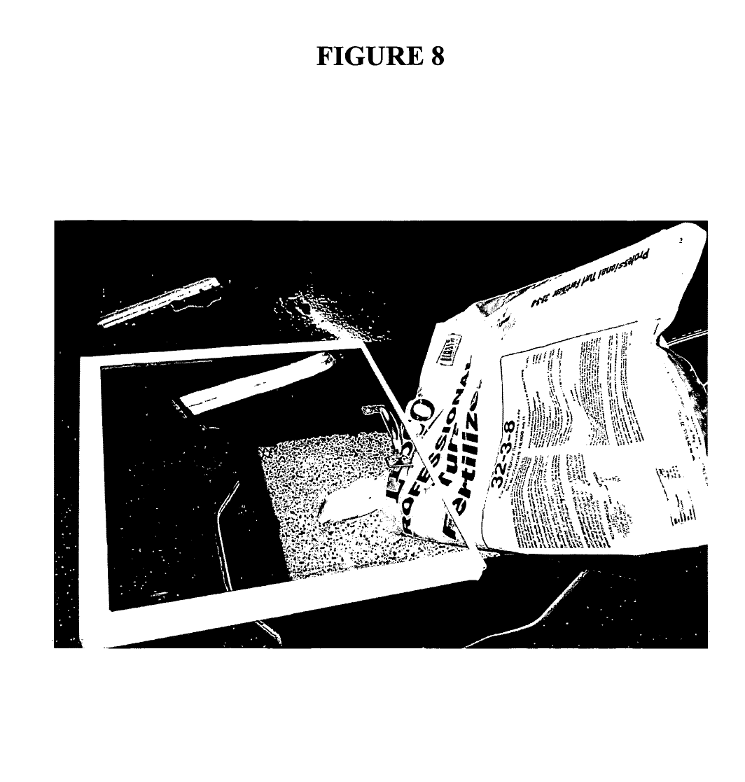

FIG. 8 shows a side view of a fertilizer spreader with an exemplary see-through spreader cover slid about half-way back. This figure also shows additional fertilizer being poured into the hopper.

The present invention is not limited by the type of manufacturing technique that is used to make the spreader covers. In certain embodiments, blow-molding techniques are employed. In other embodiments, the following steps are employed. First, a plastic sheet (e.g., Lexan) to fit the top of the hopper. Next, vinyl channels (e.g., the type used in home coverings) are cut to fit three sides of the hopper. The corners of the vinyl channel are then cut to size. Then, the corners of the vinyl channels are heated to form a corner. Then, plastic adhesive (e.g., LOCTITE POWER GRAB) is applied to the vinyl channel frame. Next, the plastic sheet is slid into the vinyl channel frame. Then, a glue a piece of vinyl or chrome channel to fit the width of the back of the plastic sheet (e.g., this piece may be configured to provide a drip edge for water to run off the cover). Finally, drill holes in the sheet and install a handle with a sealant.

Various modifications and variations of the described articles, devices, methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the relevant fields are intended to be within the scope of the claims.

I claim:

1. A system comprising:
a) a spreader device comprising a hopper with a hopper opening and hopper opening ridge, wherein said hopper is configured for holding a supply of spreadable material, and
b) a spreader cover that is configured to slide over said hopper opening ridge such said spreader cover is capable of fully enclosing said hopper opening of said hopper, wherein said spreader cover comprises:
i) a top panel that is substantially rigid and is configured to cover said hopper opening of said hopper,
ii) a back rail attached to, or integral with, said top panel,
iii) a first side rail attached to, or integral with, said top panel, wherein said first side rail comprises a first dove-tail rail, and
iv) a second side rail attached to, or integral with, said top panel, wherein said second side rail comprises a second dove-tail rail.

2. The system of claim 1, wherein said spreader device is a broadcast spreader.

3. The system of claim 1, wherein said top panel has a length of about 21½ inches and a width of about 18½ inches.

4. The system of claim 1, wherein said top panel has a length of about 28⅜ inches and width of about 18⅜ inches.

5. The system of claim 1, wherein said spreader cover is composed of plastic.

6. The system of claim 1, wherein said spreader cover is transparent.

7. The system of claim 1, wherein said spreader cover further comprises a drill hole configured for use with a pin to secure said spreader cover to said hopper.

8. A spreader cover that is configured to slide over the hopper opening ridge of a hopper of a spreader device such that said spreader cover is capable of fully enclosing the hopper opening of said hopper, wherein said hopper is configured for holding a supply of spreadable material, wherein said spreader cover comprises:
a) a top panel that is substantially rigid and is configured to cover said hopper opening of said hopper,
b) a back rail attached to, or integral with, said top panel,
c) a first side rail attached to, or integral with, said top panel, wherein said first side rail comprises a first dove-tail rail, and
d) a second side rail attached to, or integral with, said top panel, wherein said second side rail comprises a second dove-tail rail.

9. The spreader cover of claim 8, wherein said spreader device is a broadcast spreader.

10. The spreader of claim 8, wherein said top panel has a length of about 21½ inches and a width of about 18½ inches.

11. The spreader of claim 8, wherein said top panel has a length of about 28⅜ inches and width of about 18⅜ inches.

12. The spreader of claim 8, wherein said spreader cover is composed of plastic.

13. The spreader of claim 8, wherein said spreader cover is transparent.

14. The spreader of claim 8, wherein said spreader cover further comprises a drill hole configured for use with a pin to secure said spreader cover to said hopper.

15. A method of filling a spreader comprising:
a) providing:
i) a spreader device comprising a hopper with a hopper opening and hopper opening ridge, wherein said hopper is configured for holding a supply of spreadable material, and
ii) a spreader cover that is attached to said hopper such said spreader cover fully encloses said hopper opening of said hopper, wherein said spreader cover comprises:
A) a top panel that is substantially rigid and is configured to cover said hopper opening of said hopper,
B) a back rail attached to, or integral with, said top panel,
C) a first side rail attached to, or integral with, said top panel, wherein said first side rail comprises a first dove-tail rail, and
D) a second side rail attached to, or integral with, said top panel, wherein said second side rail comprises a second dove-tail rail; and
b) sliding said spreader cover back along said hopper opening ridge such that said spreader cover partially encloses said hopper opening of said hopper; and
c) pouring spreadable material into said hopper of said spreader device.

16. The method of claim 15, wherein said spreader device is a broadcast spreader.

17. The method of claim 15, wherein said hopper opening has a length of about 21½ inches and a width of about 18½ inches.

18. The method of claim 15, wherein said hopper opening has a length of about 28⅜ inches and width of about 18⅜ inches.

19. The method of claim 15, wherein said spreader cover is composed of plastic.

20. The method of claim 15, wherein said spreader cover is transparent.
